(19) United States
(12) Patent Application Publication
(10) Pub. No.: US 2022/0044164 A1
(43) Pub. Date: Feb. 10, 2022

(54) SOCIALLY DISTANT ENTERTAINMENT VENUE

(71) Applicant: VINCENT LEONARD GIAMMANCO, Ventura, CA (US)

(72) Inventor: VINCENT LEONARD GIAMMANCO, Ventura, CA (US)

(21) Appl. No.: 17/027,805

(22) Filed: Sep. 22, 2020

Related U.S. Application Data
(60) Provisional application No. 63/063,508, filed on Aug. 10, 2020.

(51) Int. Cl. G06Q 10/02; H04R 27/00; H04N 21/2187; H04N 7/15; H04N 21/4788; G07C 9/20

(52) U.S. Cl. CPC G06Q 10/02; H04R 27/00; G07C 9/20; H04N 7/15; H04N 21/4788; H04N 21/2187

(57) ABSTRACT

A 360 degree viewing stage for viewing an event or concert outdoors that provides for socially distant viewing for vehicles The venue with the stage provides a socially distant entertainment venue that provides a safe environment for both the performers and the audience while still providing an experience for the viewer that they experienced prior to the pandemic.

### RELATED PATENT APPLICATIONS

The present application claims priority to provisional patent application Ser. No. 63/063,508 filed on Aug. 10, 2020.

### FIELD OF THE INVENTION

The present invention relates to a socially distant entertainment venue having a stage that provides a safe environment for both the performers and the audience while still providing an experience for the viewer that the viewer experienced prior to the pandemic.

### BACKGROUND OF THE INVENTION

Studies show that consumers are increasingly seeking out live experiences, with concerts and music festivals. Consumers are eager to share experiences with others. With regards to prior art venues, the screen or stage is in the front, and cars parked in the back have a bad view of the stage or screen.

### SUMMARY OF THE INVENTION

The present invention relates to a socially distant entertainment venue having a stage that provides a safe environment for both the performers and the audience while still providing an experience for the viewer that the viewer experienced prior to the pandemic.

It Is an object of the present invention for the performers to be socially distanced from the crew and staff. It is an object of the present invention for the performers to be placed in a separate area from the crowd before the performance. It is an object of the present invention for all touch points in the venue to be wiped down approximately every 15 minutes. It is an object of the present invention for bathrooms to be cleaned and sanitized approximately every 15 minutes.

It is an object of the present invention for the stage to be surrounded with a free standing fence. It is an object of the present invention for the free standing fence to be about six feet high. It is an object of the present invention for the stage to be surrounded with a privacy screen.

It is an object of the present invention for security to surround the stage. It is an object of the present invention for security to maintain the gates to the venue. It is an object of the present invention for wrist bands or other physical authorization to be required for stage access,

It is an object of the present invention for performers to be driven up to the stage in a vehicle. It is an object of the present invention for security to escort performers to the stage.

It is an object of the present invention for performers to not have any interaction with the audience except on stage or via live technology. The venue for the performance is entirely outdoors. It is an object of the present invention for there to be no meet and greets. It is an object of the present invention for the audience to only be allowed to mingle with the people they came with in their vehicles. It is an object of the present invention for all guests to be required to wear face masks if they leave their vehicle. It is an object of the present invention for all staff to be Covid tested weekly and to be wearing masks. It is an object of the present invention for all staff to be checked and temperature checked,

It is an object of the present invention to have large signage and use of LEDs for messaging and public information campaigns.

The present invention relates to a stage, state of the art sound system that transmits to a car's FM radio, lighting and LED video screens. The stage provides a 360 degree viewing system, and &so provides safe distancing for all who want to watch the event. It is an object of the present invention for concert goers to see and interact with one another with the download of a Zoom link for a more connected crowd experience,

It is an object of the present invention for the venue to allow audience members to interact with the performers and other audience members via live video conference technology which is integrated into the performance allowing guests to view the live feed on their devices, along with interact with other guests, the performers on stage and be shown on the LED screens.

It is an object of the present invention to provide concerts where persons can watch from their cars. It is an object of the present invention for the cars when parked to be spaced apart and staggered to provided social distance in the venue. It is an object of the present invention for attendees to wear masks if they are viewing from the back of an SUV, outside the vehicle, or in the bed of a truck.

It is an object of the present invention for a guest to remain next to their vehicle or inside the vehicle at all times. It is an object of the present invention for no more than two people at a time to use the restroom from each vehicle. It is an object of the present invention for security to enforce rules and regulations if audience members do not maintain social distance.

It is an object of the present invention to provide theatre in the round. It is an object of the present invention for the stage to be set up in the round with vehicles parked in 360 degrees around it. It is an object of the present invention for the stage to be set up as a square with vehicles parked on each side, 360 degrees around it.

The present invention relates to a drive-in concert for everyone to enjoy from the comfort and safety of their vehicle.

It is an object of the present invention to provide safety protocols for all those who enter the venue. It is an object of the present invention for safety protocols with regards to COVID-19 to be enforced. It is an object of the present invention for all employees of the venue to be trained in safety procedures, from wearing face covering, to hand washing, to equipment handling and sanitizing. It is an object of the present invention to have temperature checks for all employees of the venue.

The present invention relates to providing a venue wherein the stage is in the round, so that cars can surround the stage, and view the entertainment from 360 degrees. It is an object of the present invention for the stage to be round. It is an object of the present invention for the stage to have four sides. It is an object of the present invention for the stage to have eight sides. It is an object of the present invention for the stage to rotate. It is an object of the present invention for the stage to be mobile. It is an object of the present invention for the stage to be stationary once it is built in the middle of the venue. It is an object of the present invention for the venue to be a flat venue for the stage to be built on.

It is an object of the present invention for the stage to be an elevated stage. It is an object of the present invention for the stage to be elevated at least 8 feet. It is an object of the present invention for the stage to have a diameter of approximately 40 feet by 40 feet. It is an object of the present invention for the stage to be set in the middle of a lot. It is an object of the present invention for the stage to be set at a point in a lot for maximum amount of vehicles to view the stage in 360 degree viewing.

The present invention relates to a stage that is lifted above the ground, set in the round, allowing for vehicles to be parked closer than they would be in a traditional front to back setting. It is an object of the present invention for LED screens to be placed on each side of the stage or all around the stage.

It is an object of the present invention for the sound to be broadcast from FM broadcast transmission and/or live sound. It is an object of the present invention for the stage to have 4 LED screens that provide a 360 degree view. It is an object of the present invention for the LED screens to be hung from the top of the stage. It is an object of the present invention for the stage to have roaming cameras. It is an object of the present invention for there to be generators for the lighting, video and audio.

The present invention provides attendees a venue to listen to the concert via FM transmitter on their radio, live stage sound, and/or via mobile app/blue tooth. It is an object of the present invention for the stage to have a sound system that uses an FM Transmitter. It is an object of the present invention for the system to include a monitor system that comprises an 8-mix stereo system. It is an object of the present invention for the system to have an RF system that is comprised of 4 channels. It is an object of the present invention for the system to have a monitor console.

It is an object of the present invention for the system to have a FOH console that is comprised of an IPad Pro in a car. It is an object of the present invention for the system to have a stage AC pack and XLR pack.

It is an object of the present invention to provide entertainment, including, live concerts, movies, Esports, gaming, boxing, corporate events and theater.

The present invention relates to a socially distant entertainment venue comprising: a venue that is completely outdoors where an audience watches a performance on a stage from their vehicles. The stage provides a 360 degree viewing system for the audience. The stage is elevated above the ground. The stage has a device that prevents the audience from reaching the stage. The venue or state includes a sound system that broadcasts to the vehicle's FM radio, via live stage sound and/or via mobile app/blue tooth. The stage has a lighting system and LED video screens on each side of said stage or surrounding said stage.

### BRIEF DESCRIPTION OF THE DRAWINGS

FIG. 1 shows an illustration of a venue of the present invention.

FIG. 2 shows the stage with the lighting above the stage.

FIG. 3 is a blown up version of the lighting shown in FIG. 2.

FIG. 4 shows the stage of the present invention.

FIG. 5 shows the stage and lighting system of the present invention.

FIG. 6 shows a top view of the stage of the present invention in a venue with attendees in vehicles.

FIG. 7 shows a side view of the stage of the present invention in a venue with attendees in vehicles.

FIG. 8 shows a top view of the stage of the present invention in a venue with attendees in vehicles.

FIG. 9 shows a top view of the venue of the present invention with attendees in vehicles.

### DETAILED DESCRIPTION OF THE INVENTION

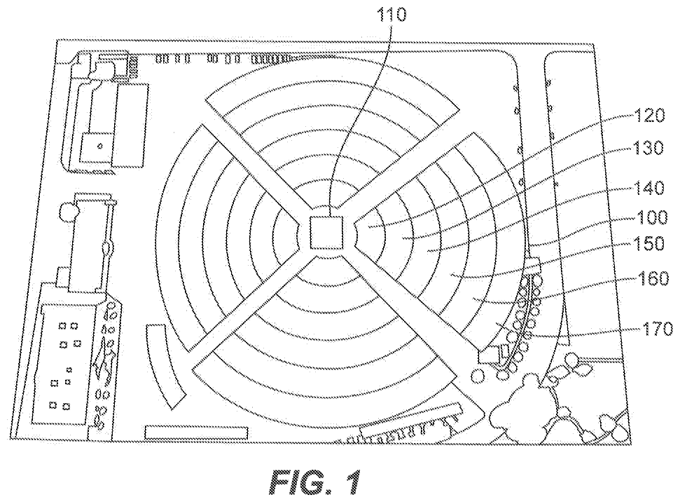

FIG. 1 shows an illustration of a venue 100 that shows a stage 110 being in the shape of a square. In this way persons parked anywhere in the lot can view the stage 110 and the performers. The stage has four LED screens one on each side of the stage 110. The venue has several rows 120, 130, 140, 150, 160 and 170. The rows are spread apart so that viewers are socially distant from each other.

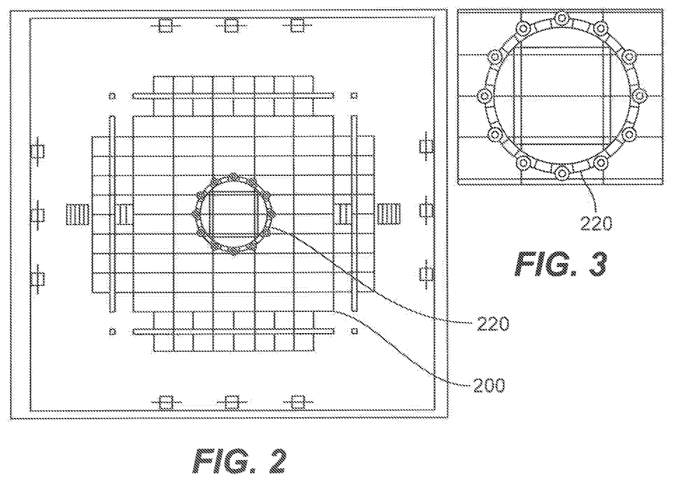

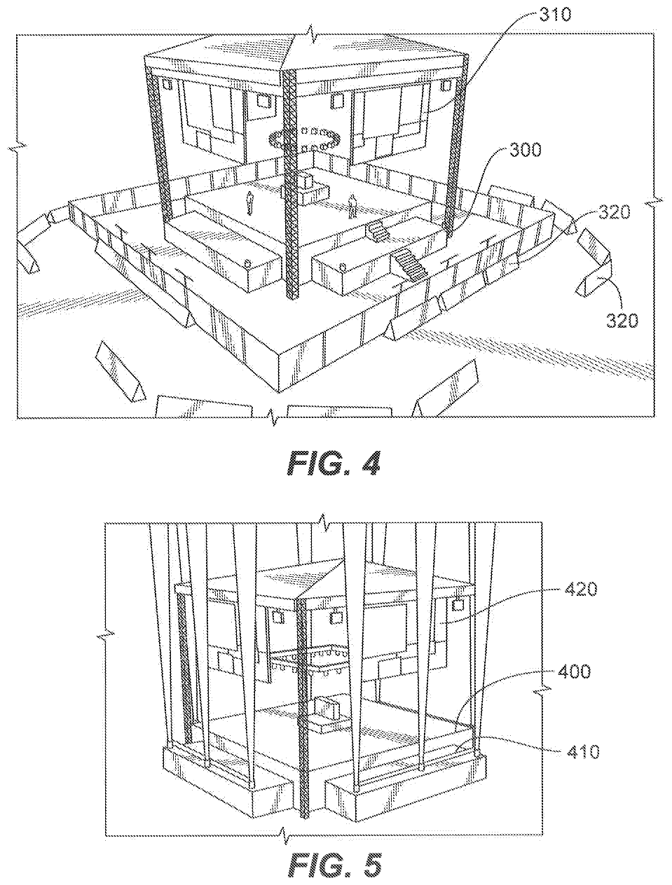

FIG. 2 shows the stage 200 having four sides and the lighting 220. FIG. 3 shows the lighting 220 of FIG. 2 in a larger version. FIG. 4 shows the stage 300 of the present invention, having LED screens 310, and fences 320,

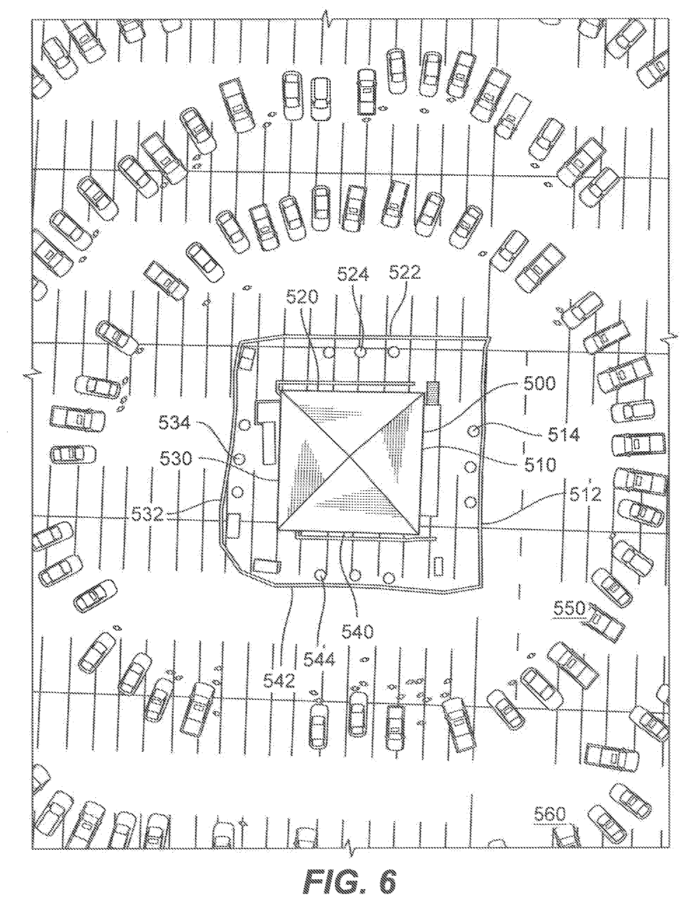

FIG. 5 shows the stage 400, lighting system 410 and LED screens 420 of the present invention.

FIG. 6 shows the stage 500 having four sides 510, 520, 530 and 540. Side 510 has a security gate 512 and lighting system 514. Side 520 has a security gate 522 and lighting system 524. Side 530 has a security gate 532 and lighting system 534. Side 540 has a security gate 542 and a lighting system 544. The stage 500 in the figure is surrounded by two rows of vehicles 550 and 560.

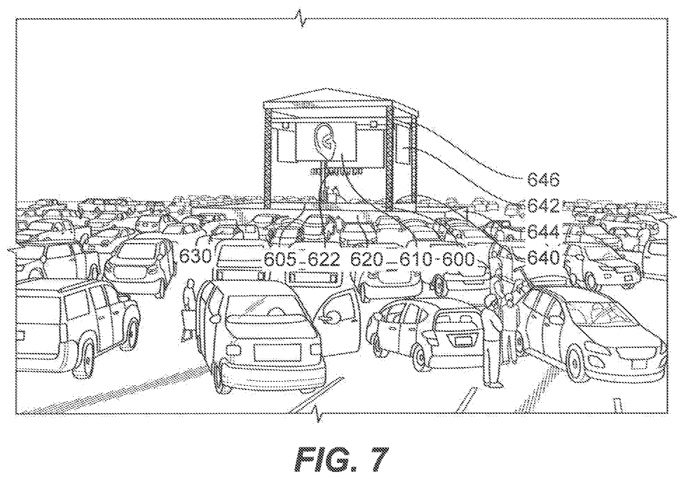

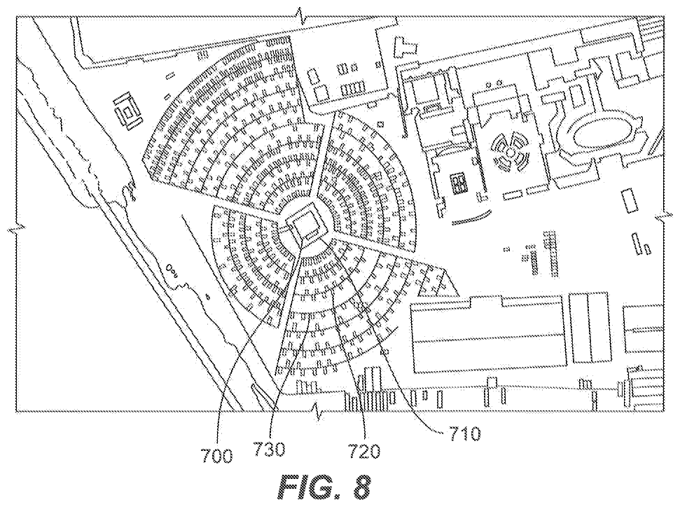

FIG. 7 shows a stage 600 having four sides, 605, 640, (other two sides not shown). Side 605 has an LED screen 610, security gate 620 and lighting 622. Side 640 has an LED screen 642, security gate 644 and lighting 646. Vehicles 630 surround the stage 600 in multiple rows.

FIG. 8 shows a stage 700 having four sides. The stage is surrounded by a gate 710. Vehicles 720 are directed into rows 730 that space the vehicles socially distant from each other. Each vehicle 720 is placed in a row 730 that surrounds the stage 700.

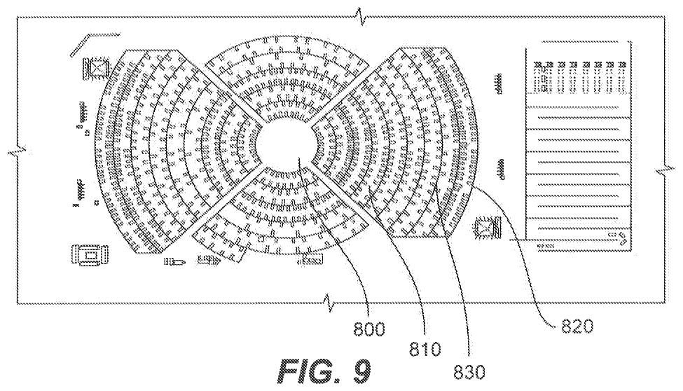

FIG. 9 shows the venue 800 where a stage (not shown) is built or placed. The venue has vehicles 810 that are placed socially distanced in the venue 800 on one of the four sides 820. The vehicles are placed in rows 830 on one of the four sides 820.

1. A socially distant entertainment venue comprising:
said venue being completely outdoors;
said venue designed so audience watches from vehicles;
a stage that provides a 360 degree viewing system for said audience;
said stage elevated above ground;
said stage surrounded by a device that prevent said audience from reaching said stage;
a sound system broadcasts to said vehicle's FM radio, via live stage sound and/or via mobile app/blue tooth;
a lighting system;
LED video screens on each side of said stage or surrounding said stage,

2. The venue of claim 1 wherein said venue provides a safe environment for both performers and audience while allowing audience to view performers.

3. The venue of claim 1 wherein said stage is surrounded by a privacy screen.

4. The venue of claim 1 wherein security surrounds said stage and maintain gates around said venue.

5. The venue of claim 1 wherein wrist bands or other physical authorization is required for access to said stage.

6. The venue of claim 1 wherein audience must stay with vehicle that brought them to said venue and audience members must wear face masks if leave said vehicle,

7. The venue of claim 1 wherein said venue comprises large signage and use of LEDs for messaging and public information campaigns.

8. The venue of claim 1 wherein audience interact with one another with download of a Zoom link.

9. The venue of claim 1 wherein said venue provides audience members technology to interact with performers and other audience members via live video conference technology integrated into performance so audience members can view live feed on theft devices, and &so interact with other guests, performers on said stage and be shown on said LED screens.

10. The venue of claim 1 wherein said vehicles are spaced apart and staggered to provide social distancing.

11. The venue of claim 1 wherein said stage is mobile.

12. The venue of claim 1 wherein said stage is stationary once it is built in place in said venue.

13. The venue of claim 1 wherein said stage has four sides.

14. The venue of claim 1 wherein said stage has eight sides.

15. The venue of claim 1 wherein said stage rotates.

16. The venue of claim 1 wherein said stage is round.

17. The venue of claim 1 wherein said device is a free standing fence.

18. The venue of claim 1 wherein said stage has a diameter of approximately 40 feet by 40 feet.

19. The venue of claim 1 wherein said stage is set at a point in said venue providing a maximum amount of vehicles to view said stage.

20. The venue of claim 1 wherein said LED screens are hung from top of said stage.

21. The venue of claim 1 wherein said venue has multiple rows for said vehicles to park that surround said stage and keep said audience socially distant from each other.

22. The venue of dam 1 wherein said venue is flat.

21. A socially distant entertainment venue comprising:
said venue being completely outdoors;
said venue designed so audience watches from vehicles;
a stage that provides at least a 270 degree viewing system for said audience;
said stage elevated above ground;
said stage having a device that prevents said audience from reaching said stage;
a sound system broadcasts to said vehicle's FM radio, via live stage sound and/or via mobile app/blue tooth;
a lighting system;
LED video screens on each side of said stage.
